(19) United States
(12) Patent Application Publication
(10) Pub. No.: US 2012/0094869 A1
(43) Pub. Date: Apr. 19, 2012

(54) MICROPLATE ASSAY KIT

(75) Inventors: Samad TALEBPOUR, Richmond Hill (CA); Stephen W. LEONARD, Unionville (CA); Keith BECKLEY, King City (CA); Robert MAASKANT, King City (CA)

(73) Assignee: NOVX SYSTEMS INC., Richmond Hill (CA)

(21) Appl. No.: 13/336,063

(22) Filed: Dec. 23, 2011

Related U.S. Application Data
(63) Continuation-in-part of application No. 11/363,251, filed on Feb. 28, 2006, now Pat. No. 7,555,659.

(51) Int. Cl. C40B 40/00

(52) U.S. Cl. 506/13

(57) ABSTRACT

The present invention provides a microplate-based assay kit that incorporates all assay reagents and standards in a simple and efficient format and may be used in biochemical assays. The assay kit includes pre-filled, pre-sealed and barcoded microplates with a standard physical footprint for use in a microplate-based automated analyzer system which enables simple and efficient operation by an unskilled user via per-use factory-sealed and barcoded reagent and calibrator microplates. Such microplates allow the user to run a broad test menu without the need to monitor the arrangement and supply of internally stored reagents and standards, thus greatly simplifying the user experience and eliminating the need for highly skilled users.

### CROSS-REFERENCE TO RELATED APPLICATION

This application is a continuation of U.S. patent application Ser. No. 11/363,521 filed on Feb. 28, 2006, in the name of the same inventors, entitled MICROPLATE ASSAY KIT, which is incorporated herein by reference in its entirety.

### FIELD OF THE INVENTION

The invention relates to the use of microplates in biochemical assays. In particular, the invention relates to the use of microplate cartridges for the storage and delivery of reagents and standards used in automated analyzer systems.

### BACKGROUND OF THE INVENTION

Biochemical assays are routinely performed by automated analyzer systems for the accurate determination of a wide variety of analytes. Analyzer systems such as clinical chemistry analyzers or immunoassay analyzers typically incorporate a number of specialized subsystems, including precise automated pipetting systems for the dispensing of liquids, complex thermal management systems, robotic transfer systems, and optical detection systems. Reagents and standards for assays are provided in large containers that are typically stored within the analyzer in cooled housings, and the involvement of a skilled operator is necessary for operation, maintenance and inventory management.

Although such analyzer systems are well suited for laboratories that process a large volume of samples and employ skilled lab technicians, they are too complex and costly to operate in smaller clinical settings where only unskilled personnel are available. One particular problem with complex analyzer systems is the need to manage the inventory of internally-housed cartridges containing reagents and standards.

These cartridges are typically plastic multi-container vessels that store several different reagents and standards pertaining to a given assay. For example, U.S. Pat. No. 4,970,053 (Beckman Instruments, Inc.) discloses a multi-compartment reagent cartridge for use in an automated analyzer system. Similar multi-compartment reagent cartridges are also disclosed in U.S. Pat. No. 5,985,218 and U.S. Pat. No. 6,149,872. Although the on-board storage of such cartridges enables a broad test menu for the analyzer, it also necessitates the frequent maintenance of the analyzer system and the careful management of on-board inventory. The high level of operator skill needed for such tasks thus precludes the use of such analyzer systems in smaller clinical settings. In order to avoid the onerous maintenance and operator skill level requirements of an analyzer system with on-board reagents, a simpler means for the storage and transport of reagents and standards is required.

One step towards a simplified means of reagent storage and transport is provided in the prior art by microplate-based reagent storage devices, in which one or more reagents are stored in microwells arranged in a standard microplate format. For example, it is well known among those skilled in the art that automated liquid dispensing systems can be used to pre-dispense reagents and standards in microplate formats prior to performing a microplate-based assay in which the same automated liquid dispensing system is used for liquid transfer (an optical reading subsystem is typically integrated into the system). This approach, however, suffers from many drawbacks that preclude its use in smaller clinical settings. Most importantly, the reagents and standards need to be properly aliquoted into special troughs prior to using the automated liquid dispensing system for the filling of reagent and sample microplates. Individual reagents and standards thus need to be stored separately, necessitating careful control of inventory and shelf life. Furthermore, the need for custom programming and frequent maintenance of the liquid dispensing system requires a very high degree of operator skill.

A further improvement over this approach involves pre-sealing the reagent microplates prior to shipping, so that the user need not have to aliquot individual reagents into the microplate wells. Such pre-sealed reagent microplates are also well known in the prior art and are commonly employed in a number of different assay formats. For example, linear arrays of pre-sealed microplates (the so-called “stripwell” format) with antibodies lyophilized on the bottom surface of the microwells are a popular reagent format for conducting enzyme-linked immuno-sorbent assays (ELISAs). In such a format, additional reagents required for performing the assays are included in bottles and are dispensed by the user.

Another well-known application for utilizing pre-sealing reagent microplates is protein crystallography. This format does not involve conventional biochemical assays, in which a concentration of an analyte is determined from a dose-response curve. Instead, the format provides a number of test microwells with different conditions for the growth of protein crystals.

United States Patent Publication 2004/0187958 A1 discloses a novel pre-filled microplate format for conducting vapour-diffusion protein crystallization studies. The reagents are arranged in a standard microplate format and sealed prior to shipping, enabling the user to perform a large number of parallel protein crystallization experiments with minimal liquid dispensing. Similar pre-filled microplates are also commercially available from vendors such as Sigma-Aldrich Co. and Qiagen Inc.

Despite the innovations disclosed in the prior art, a simple reagent kit for performing biochemical assays remains elusive. In particular, the prior art fails to provide a means for including both standards (i.e. calibrators and controls) and reagents in self-contained and sealed microplate kit format, and also fails to provide a means for the identification and usage of individual reagents and standards via an automated analyzer system.

### SUMMARY OF THE INVENTION

The present invention provides a microplate-based assay kit that incorporates all assay reagents and standards in a simple and efficient format. Unlike complex automated analyzer systems common in the prior art, a microplate-based analyzer system utilizing a microplate based assay kit according to the present invention enables simple and efficient operation by an unskilled user via per-use factory-sealed and barcoded reagent and calibrator microplates. Such microplates allow the user to run a broad test menu without the need to monitor the arrangement and supply of internally stored reagents and standards, thus greatly simplifying the user experience and eliminating the need for highly skilled users.

In one aspect of the invention there is provided a microplate assay kit for performing one or more assays on one or more unknown samples, comprising;

one or more sealed and labeled, microplates, wherein each of said one or more assays determines a different analyte, and wherein said microplates contain a plurality of microwells, and wherein said microplates include:

for each reagent required to perform each of said one or more assays, at least one distinct microwell containing said each reagent; and

at least one microwell containing a known concentration or amount of one or more analytes to be determined by said one or more assays, whereby a sufficient number of microwells containing said known concentration or amount of one or more analytes are included for the calibration of a dose-response curve for each of said one or more assays;

and wherein said microplate assay kit contains all necessary reagents and standards for calibrating said one or more assays and for performing said one or more assays on one or more unknown samples, and whereby said one or more sealed microplates enable shipment and storage of said microplates without harm to said reagents and said known concentrations or amounts of analyte while also providing a physical layout that enables rapid and convenient manual or automated liquid dispensing when performing said one or more assays in a microwell-based format.

In another aspect of the invention there is provided a microplate assay kit for performing one or more assays on one or more unknown samples, comprising;

one or more sealed and labeled microplates, wherein each of said one or more assays determines a different analyte, and wherein said microplates contain a plurality of microwells, and wherein said microplates include: for each reagent required to perform each of said one or more assays, at least one distinct microwell containing said each reagent; and

for each reagent required to perform each of said one or more assays, one or more additional distinct microwells containing said each reagent, wherein

for one reagent of said each assay, said one or more additional distinct microwells also contain a known concentration or amount of an analyte to be determined by said each assay, whereby a sufficient number of said additional distinct microwells also containing a known concentration or amount of an analyte to be determined by said each assay are included for the calibration of a dose-response curve for each of said one or more assays;

and wherein said microplate assay kit contains all necessary reagents and standards for calibrating said one or more assays and for performing said one or more assays on one or more unknown samples, and whereby said one or more sealed microplates enable shipment and storage of said microplates without harm to said reagents and said known concentrations or amounts of analyte while also providing a physical layout that enables rapid and convenient manual or automated liquid dispensing when performing said one or more assays in a microwell-based format.

A further understanding of the functional and advantageous aspects of the invention can be realized by reference to the following detailed description and drawings.

### BRIEF DESCRIPTION OF THE DRAWINGS

The invention will be more fully understood from the following detailed description thereof taken in connection with the accompanying drawings, which form a part of this application, and in which:

FIG. 1 shows an embodiment of a microplate assay kit including a microplate and a rectangular array of microwells arranged in rows and columns with a first reagent located in the microwells of the first column, a second reagent located in the microwells of the second column, and a known concentration or amount of assay standards C1 to C8 stored in the microwells of the third column;

FIG. 2 shows the locations of the dispensed reagents, samples and standards on a reaction microplate when a reagent plate according to FIG. 1 is used to perform an assay;

FIG. 3 shows a reagent microplate that contains a pair of columns containing reagents R1 and R2 for six different assays measuring six different analytes;

FIG. 4 shows a separate calibration microplate which is a half-filled 96-microwell microplate containing a set of eight different standards in each column (R1 to R8), with a separate column for each of the six analytes;

FIG. 5 shows the locations of the dispensed reagents and standards on a reaction microplate for the calibration assays where one observes that each reagent and standard is dispensed into a single microwell of an assay-specific column on the reaction microplate shown in FIGS. 3 and 4;

FIG. 6 shows the locations of the dispensed reagents and samples on a reaction microplate where, each reagent from each microwell on the reagent microplate of FIG. 3 is dispensed into two microwells on the reaction microplate so that the entire reaction microplate is utilized;

FIG. 7 shows a reagent containing microplate which is a modification of the microplate shown in FIG. 3 in which a row of reagents (row H) has been replaced with a row of two control standards (alternating C1 and C2), which can be used in a microplate assay kit which includes a reagent microplate as shown in FIG. 3 and the calibration microplate shown in FIG. 4;

FIG. 8 shows another embodiment of a microplate which is an alternative to the reagent microplate of FIG. 7 and which is similar to the microplate of FIG. 3 with the exception that the two microwells in row H of columns 11 and 12 contain control standards; and

FIG. 9 shows an another alternative embodiment of a microplate assay kit in which the microwells of the microplate contain standards to be employed as calibrators (C) or controls premixed with a reagent (R).

### DETAILED DESCRIPTION OF THE INVENTION

The present invention is hereby described by way of several non-limiting examples. In a first example, an assay kit according to the present invention is described in the context of performing a simple mix-and-read assay (i.e. a homogeneous, non-separation assay) with a microwell-based automated analyzer system. The analyzer is assumed to be capable of performing the following automated functions: recognition of barcodes applied to microplates, liquid dispensing between two or more standard microplates, sample dispensing from sample vessels mixing or agitation of one or more microplates, and optical detection of an assay signal. In addition, the automated analyzer system is assumed to be capable of providing the stable thermal environment required by the assay.

The analyzer may also be capable of automatically piercing sealed microwells in a microplate, but this is not a requirement as the operator may perform the piercing prior to loading the microplates in the analyzer. The assay is performed by combining, in a reaction microwell, a first reagent (R1), a second reagent (R2) and a sample; agitating or mixing the liquid within the reaction microwell; and measuring an optical assay signal originating from or absorbed by the liquid within the reaction microwell. The analyte concentration within the sample is obtained from a dose-response curve, which relates a measured assay signal to a corresponding concentration via a mathematical function. The dose-response curve is obtained by plotting the signals measured for a set of known standards against the concentrations of the known standards and fitting the resulting data points to a general mathematical function. The process of establishing the dose-response curve is known as “calibrating” the assay.

The invention provides a microwell kit in the form of a single sealed microtiter plate containing reagents and standards for calibrating the assay and performing the assay on a plurality of unknown samples. A microtiter plate, or “micro plate” as used hereinafter, is an array of multiple “wells” that are used as small test tubes. The microplate has become a standard tool in analytical research and clinical diagnostic testing laboratories. It typically can have 6, 24, 96, 384 or 1536 sample wells arranged in a 2:3 rectangular matrix. Microplates have also been manufactured with 3456 or even 9600 wells. Each well of a microplate typically holds somewhere between a few to a few hundred microliters of liquid. The term “microplate”, as used herein, describes both a solid two-dimensional array of microwells, and also a single one-dimensional linear array of microwells (the so-called “stripwell” format), where the stripwell is placed in an appropriate supporting device (such supports are well known in the prior art).

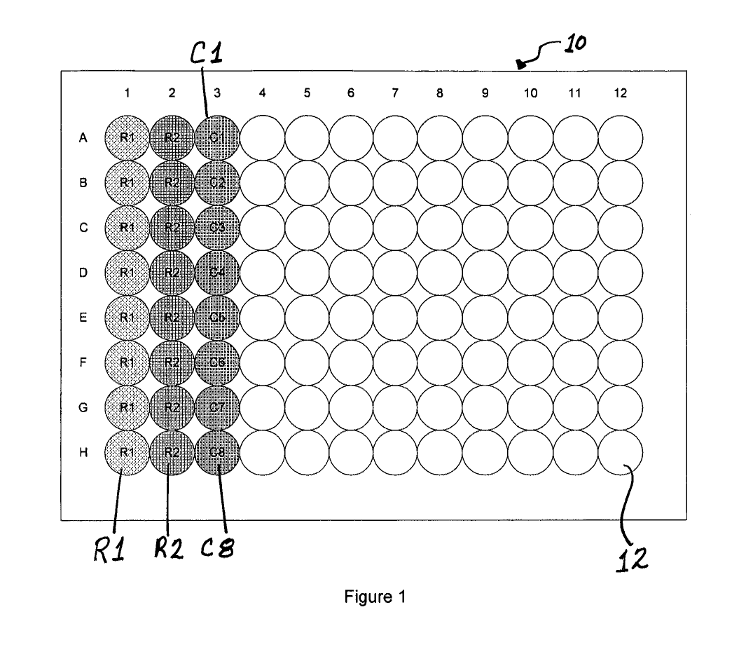

As shown in FIG. 1, a micro plate 10 is provided in a standard format comprising a two-dimensional array of 96 substantially cylindrical microwells 12, where the physical dimensions of the microplate may conform to an industry standard. The microplate 10 is preferably made out of polypropylene (or polystyrene), and exemplary microplates of this type are available from companies such as Nunc Inc. and Corning Inc. The microwells 12 preferably have either a conical or U-shaped base to enable the optimal extraction of reagents or standards with minimal residual waste.

The reaction microwells 12, into which the reagents and samples are dispensed, are also provided in standard microplate format. Since this reaction microplate 10 is a standard microplate that is commercially available and does not require any further preparation for use in the assay, it is not considered to be an element of the inventive assay kit. Furthermore, additional standard consumables, such as pipette tips and wash buffers that are used across multiple assay types, are also not considered to be part of the assay kit. The reaction microplate 10 is typically a clear, flat-bottom microplate preferably made of polystyrene (or polypropylene) and is advantageously used for the measurement of absorbance. If the assay signal arises from luminescence or fluorescence, it may be preferable to use an opaque reaction microplate that is black or white.

Referring again to FIG. 1, the microplate 10 comprising the assay kit in the present embodiment of the invention is shown in a top view prior to being sealed. Column 1 contains a set of eight (A-H) microwells, each containing a substantially equal volume of R1. The second column contains R2 in a similar fashion. The microwells in columns 1 and 2 each contain a sufficient amount of reagent to perform two assays. The third column 3, however, contains a set of eight microwells containing standards, each having a different concentration of the analyte to be determined by the assay. The volume of the different standard solutions is substantially equal across column 3, and there is sufficient volume in each microwell 12 to perform a single assay. Although there are eight standards shown in FIG. 1, only a sufficient number of standards to obtain a suitable dose-response curve need be included in column 3.

The microplate 10 is filled with R1, R2 and standards with concentrations C1-C8 in a production environment prior to shipping and storage. After filling the microplate 10 with the reagents and standards, the microplate is sealed with a sealing material that is sufficient to prevent liquid leakage and evaporation. The preferred sealing material is a metallic foil, such as aluminum. The thickness of the foil is preferably at least 20 microns thick so that evaporation is substantially prevented and a sufficient shelf life of the sealed microplate can be obtained. The foil may preferably by pierced by a piercing means such as a pipette tip, a standard plastic piercing array (known in the prior art and commercially available), or a metallic rod with a chiseled piercing tip. Alternatively, the foil may be peelable. The seal can be applied in a number of methods, including adhesives, pressure, heat, or any combination of these methods.

After filling and sealing, the microplate 10 is labeled with one or more text labels that provide information to the user that may include the serial number, shelf life, vendor name, lot number, trademarks and any other pertinent information. In a preferred embodiment of the microplate labeling, the microplate is also barcoded with a machine-readable medium such as optical one or two-dimensional barcodes or radio-frequency identification barcodes. The microplate assay kit, comprising the sealed and labeled microplate containing reagents and standards, thus provides a novel format for the simple and efficient transport and storage of a multitude of individual reagents and standards. The reagents and standards in the individual microwells are readily accessed by an automated microplate analyzer, eliminating the need to store a complex arrangement and inventory of individual bottles (or cartridges) as typically done in a traditional automated analyzer system. This simplicity of design and ease of use of the inventive assay kit, when used in combination with an automated microplate analyzer system, enables new applications for clinical analyzer systems that go beyond the scope of laboratory-based settings and offer real solutions for smaller clinics with unskilled staff.

The assay is performed in the automated microplate analyzer by first loading the microplates into the analyzer. In a preferred embodiment, an internal barcode reader detects the identity and location of all reagent and standard microwells on the assay kit microplate via a barcode located on the microplate. The analyzer is then configured by the user to perform the assay on a selected group of unknown samples and to perform an assay calibration via the standards C1 to C8 stored in column 3 of the reagent microplate (i.e. the assay kit microplate). The analyzer, preferably equipped with an eight-channel pipettor, aspirates the programmed quantity of R1 from all microwells in column 1 of the reagent microplate and dispenses the reagent into column 1 of the reaction microplate.

The analyzer then once again aspirates R1 from all microwells 12 in the first column 1 of the reagent microplate 10 (as described above, the microwells 12 contain sufficient reagent for two assays) and dispenses the reagent into the microwells in column 2 of the reaction microplate. Up to eight samples are then pipetted into the microwells in first column 1 of the reaction microplate 10, and the action is preferably performed serially via a single-channel sample dispensing pipettor. The analyzer then aspirates a programmed quantity of standard C from each microwell in column 3 of the reagent microplate and dispenses the standard into the second column 2 of the reaction microplate 10. Finally, the programmed volume of R2 from each microwell in the second column 2 of the reagent microplate is aspirated and dispensed into the first column 1 of the reaction microplate, initiating the assay reaction for that column.

This process is repeated so that the microwells in the second column 2 of the reaction microplate also receive the programmed volume of R2 from the second column 2 of the reagent microplate 10. The reaction microplate 10 is then agitated to facilitate the assay reaction and the optical signal is read in an endpoint or kinetic fashion for each microwell in the first two columns 1 and 2 of the reaction microplate according to the desired assay timing. Prior to determining the concentration of analyte in the samples, the assay signals obtained from the second column of the reaction microplate (containing the known standards) are first employed to determine a dose-response curve for the assay, according to the aforementioned method. The dose-response curve and the individual assay signals are then employed to determine the analyte concentrations for each unknown sample.

The microplate 10 shown in FIG. 1 is clearly underutilized given the total number of microwells 12 available. Accordingly, the remaining 9 columns can be filled with sets of R1, R2 and standards for the same assay, or for different assays. In this manner, a number of different assays may be calibrated and performed via a single multi-assay reagent microplate. Furthermore, the number of assays provided by a single microplate can be increased by adopting a microplate format with a larger number of microwells, e.g. the commercially available and standardized 384 or 1536-well microplate formats.

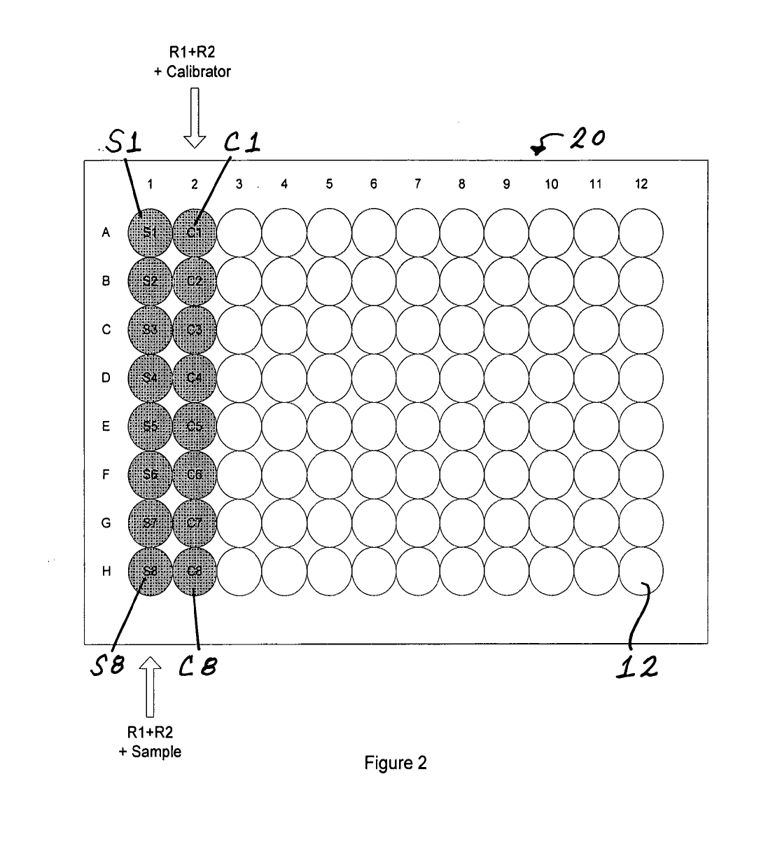

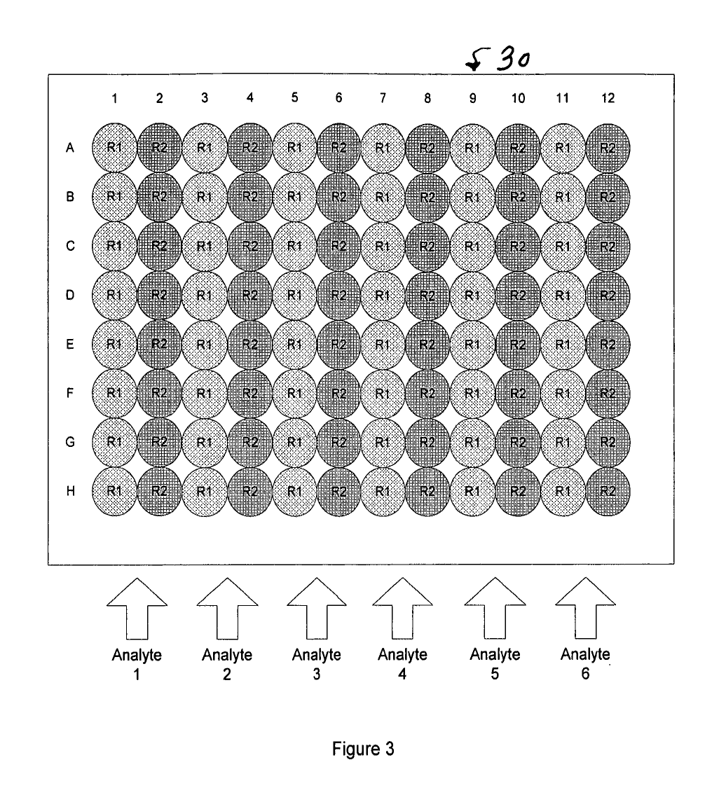

Although the above example provides a compact and self-contained assay kit with many advantageous features, it may not be necessary to perform an assay calibration each time unknown samples are to be measured. Indeed, many assays can endure relative long time periods (i.e. weeks) before needing recalibration. It is therefore desirable to have an assay kit that provides standards that can be accessed in a separate microplate for periodic assay calibration. An example of such an assay kit is shown in FIGS. 2 and 3, where a reagent microplate 20 (FIG. 2) and a separate calibration microplate 30 (FIG. 3) are schematically illustrated. The reagent microplate 20 is shown as a 96-microwell microplate in a multi-assay format, with six different two-reagent mix-and-read assays determining different analytes. As in the previous example, a sufficient volume of each reagent is provided to enable the performance of two assays. The reagent microplate 20 can be employed both for the measurement of unknown samples and also for the measurement of standards for the determination of the dose-response curves for the assays. The calibration microplate is a half-filled 96-microwell microplate containing a set of eight different standards in each column, with a separate column for each of the six analytes. For each different assay, a sufficient number of different standards are included to obtain a suitable dose-response curve.

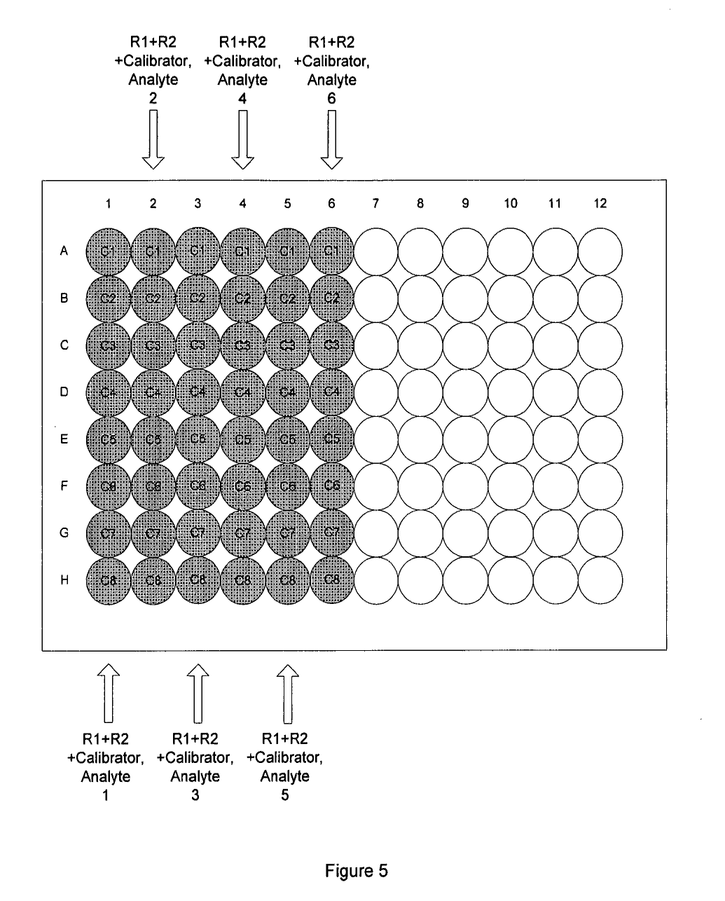

The assays are performed in an automated microplate analyzer as follows. Before assaying unknown samples, a reagent and a calibration microplate are first employed to determine dose-response curves for each of the six different assays. The different assays may either be performed serially or in parallel, depending on the capability of the automated analyzer. This is achieved by performing the six mix-and-read assays in a similar manner to that described in the previous single-assay and single-microplate example, in which the reagents are dispensed in the following order: R1, standard, and R2. The locations of the dispensed reagents and standards on the reaction microplate for the calibration assays are shown in FIG. 5, where one observes that each reagent and standard is dispensed into a single microwell of an assay-specific column on the reaction microplate. The unused reagents (recall that the reagent microwells were filled with sufficient reagent for performing two assays) may be used to perform assays on unknown samples after the completion of the calibration assays. Alternatively, in another embodiment, a separate reagent microplate can be used for calibration assays, where the volumes of the reagents in the microwells of the separate reagent microplate can be filled with only enough reagent to perform a single assay, in which case the residual reagent volumes are minimized. As previously described, the assays signals from the microwells of each column on the reaction microplate are used to construct dose-response curves for the six assays.

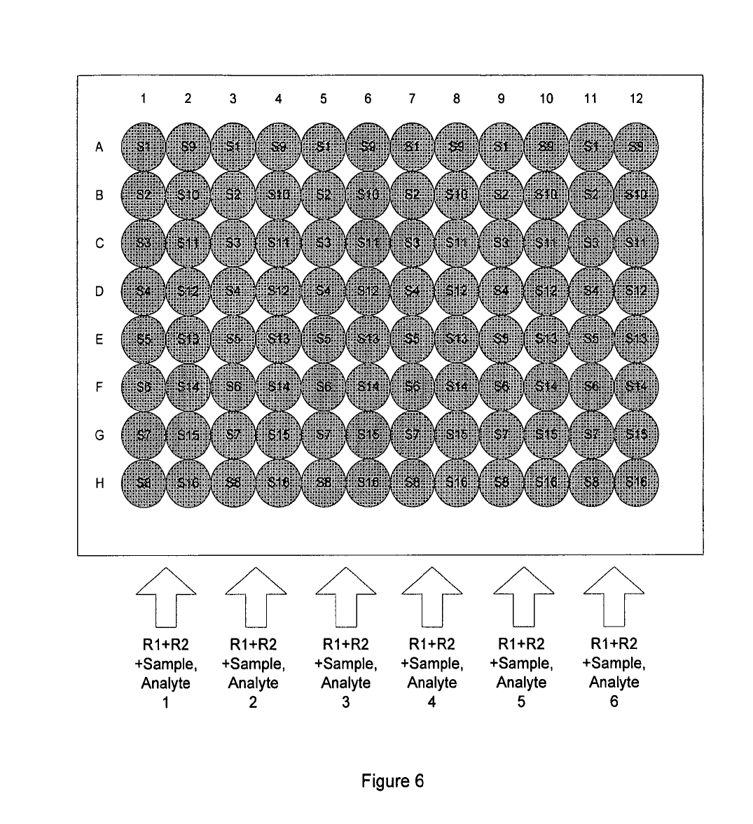

Once a calibration has been performed for all six assays, the reagent microplate alone can be used to perform assays on unknown samples. The automated microplate analyzer performs the six assays by dispensing the reagents and samples in the following order: R1, samples, R2. The locations of the dispensed reagents and samples on the reaction microplate are shown in FIG. 6. In this case, each reagent from each microwell on the reagent microplate is dispensed into two microwells on the reaction microplate so that the entire reaction microplate is utilized. As shown in FIG. 6, each assay occupies two columns on the reaction microplate, enabling the measurement of a total of sixteen samples for each of the six assays. The sixteen samples can be common among all six assays, or different if desired.

In this preferred embodiment, the user first employs a reagent microplate and a calibration microplate to calibrate the six assays. With the six dose-response curves determined for the assays, the user can then use other reagent microplates for the measurement of unknown samples. The analyzer can be configured to analyze the unknown samples in a batch or STAT configuration, depending on the preference of the user and the capability of the analyzer. This particular example illustrates how the invention provides a dramatic simplification in the management of the reagents and standards of a plurality of different assays.

Although the two aforementioned embodiments have focused on two specific layouts of microplate assay kits, a wide variety of different layouts are anticipated by the invention. In its most basic form, the invention only requires a microplate containing sufficient reagents and standards to perform and calibrate a single assay for a single sample. In a more general form of the invention, the assay kit may contain many microplates with reagents for performing and calibrating a plurality of different assays on a plurality of samples. One subset of the many microplates may be used for performing calibration of the assays, and different subsets of the many microplates may be used for the measurement of unknown samples for one or more of the different assays. Furthermore, the microwells may contain sufficient reagents for a single assay, or more than one assay if desired. Also, a microwell containing a standard may contain more that one analyte so that the standard in the microwell can be employed for more than one assay (provided that there is a sufficient amount of the standard in the microwell).

The physical layout of reagents and standards need not lie in a columnar fashion, although such an arrangement is preferred for multichannel pipetting systems capable of parallel dispensing. Alternatively, the layout of reagents may preferably be done along rows rather than columns, which enables a columnar multichannel pipette to dispense multiple reagents for different assays in a parallel fashion. In this case, many different assays can be simultaneously run on a single sample in multiple microwells via multichannel liquid dispensing.

In addition to standards for the calibration of assays, another common component of an assay kit is additional standards that are assayed as controls. Such standards, when assayed after having completed an assay calibration, allow the user to verify the performance of the analyzer system by comparing the concentration reported by the analyzer to the known concentration of the standard. The present invention provides two distinct means of assaying controls that verify assay performance.

In a first embodiment, controls are not included in the microplates comprising the assay kit, but are provided separated by the user (either to be purchased commercially or prepared by user) and run within the analyzer as samples. This embodiment illustrates a common and well known usage of controls in analyzer systems.

In another embodiment, additional microwells containing a known standard for one or more assays to be run via the microplate assay kit are included on at least one of the microplates. The location and analyte concentration of the standards are provided on the microplate label. In a preferred embodiment, the label includes a barcode that enables an analyzer equipped with a barcode reader to directly ascertain the identity and location of the standard.

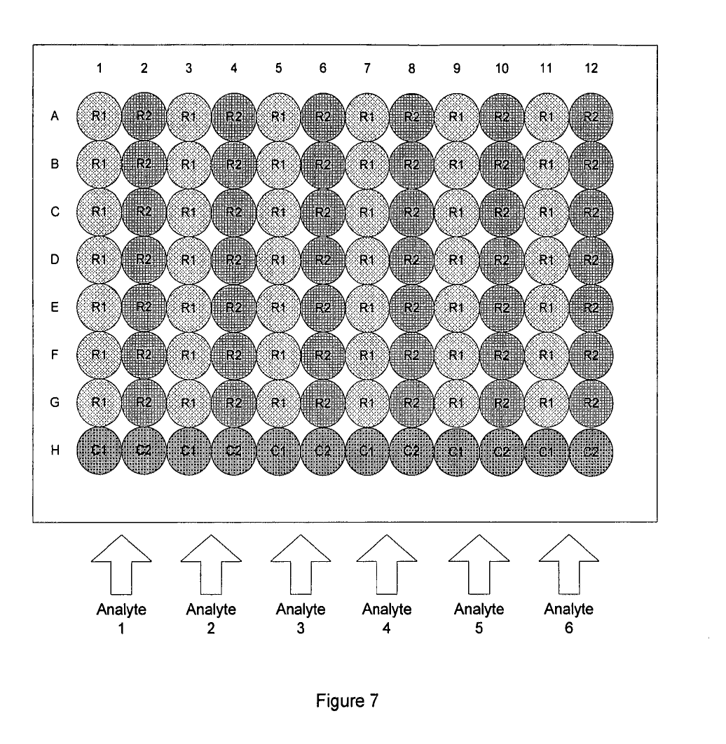

To further illustrate the direct inclusion of control standards in a microplate assay kit according to the present invention, a modification of the recent example is considered in which the reagent microplate also includes such standards. The modified reagent microplate is shown in FIG. 7, and comparing this figure with FIG. 3, one readily observes the replacement of a row of reagents with a row of control standards. There are two control standards for each assay, with the two standards preferably having known analyte concentrations above and below an assay cutoff (i.e. a clinical decision threshold).

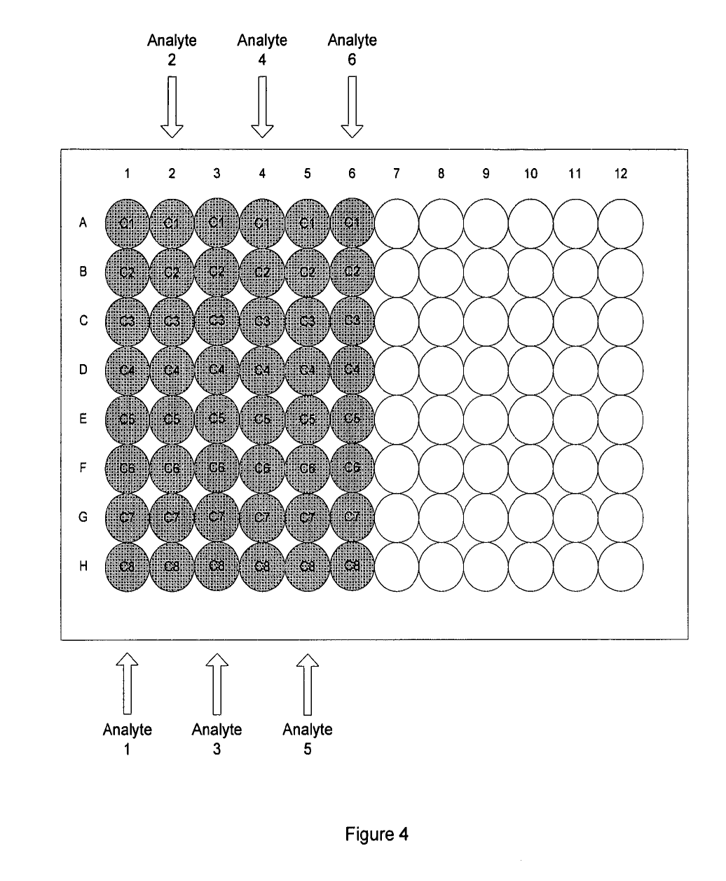

The microplate assay kit according to this preferred embodiment includes a reagent microplate as shown in FIG. 3 and a calibration microplate according to FIG. 4, with the pair being used together for the calibration of all six assays, and the kit also contains one or more reagent microplates as shown in FIG. 7 for the measurement of unknown samples.

The measurement of unknown samples in an automated analyzer system proceeds as follows. After loading a reagent microplate containing control standards (according to FIG. 7), the analyzer first dispenses R1 from column 1 of the reagent microplate into columns 1 and 2 of the reaction microplate, as previously described. However, in this case, R1 is only aspirated and dispensed for rows A-G, since row H contains standards. Secondly, samples are dispensed into rows A-F. Thirdly, standard C1 from microwell H of the first column of the reagent microplate is dispensed into microwell G of the first column of the reaction microplate, and the similar sequence is performed for the second column to dispense standard C2. Row H of the reaction microplate is left empty. Finally, R2 from rows A-G of column 2 of the reagent microplate is dispensed into rows A-G of columns 1 and 2 of the reaction microplate, initiating the assay reaction.

The assay proceeds as previously described, and the assay signals from microwells A-G of each column are measured. This process is performed for each of the six assays, aspirating from and dispensing to the appropriate columns for each different assay. Alternatively, the multiple assays can be performed in parallel if the automated analyzer is capable of performing in such a mode. The previously determined dose-response curve for each assay is then employed to determine each sample concentration and also a measured concentration for each control standard. The measured concentrations of the control standards are compared with their known values, and the assays are deemed verified and valid if the comparisons all pass predetermined test criteria.

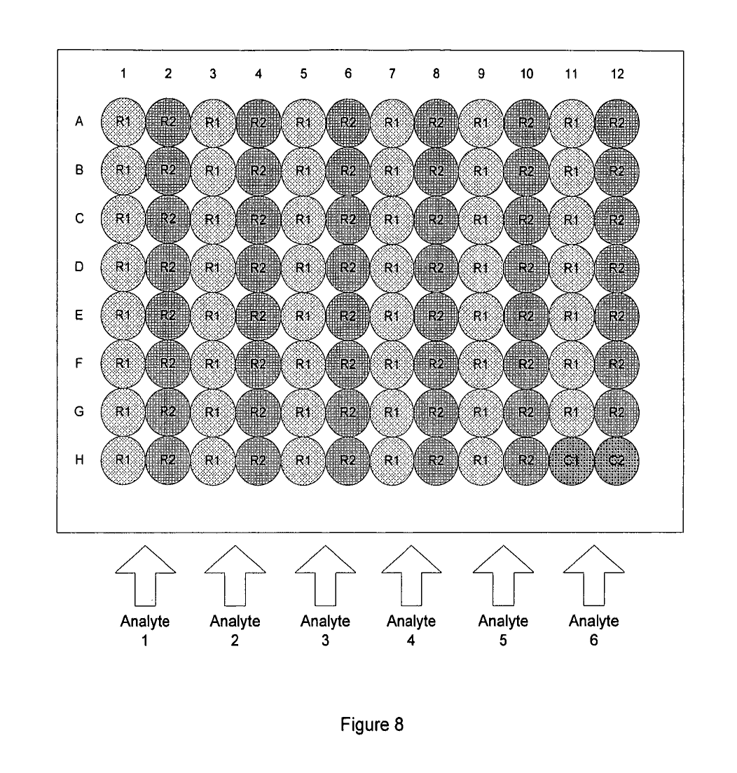

The aforementioned embodiment, while providing a means of verifying the performance of each assay of the microwell kit, has the disadvantage of substantially limiting the throughput of the analyzer system and thereby increasing the net cost per test. A preferred embodiment is shown in FIG. 8, where an alternative to the reagent microplate of FIG. 7 is provided. The reagent microplate is very similar to that of FIG. 3, with the exception that the two microwells in row H of columns 11 and 12 contain control standards. Unlike the single drug control standards shown in FIG. 7, the two control standards contain concentrations of all six analytes and can therefore be used as a common source of control standards for all assays. In a preferred embodiment, the two microwells provide two different analyte concentrations for each assay and each microwell contains a sufficient volume of standard to be used six times.

If the maximum working volume of the microwell is not sufficient to accommodate the required standard volume, the two microwells can contain the same multi-analyte concentrations and therefore only need to supply enough standard for three assays each. In this higher throughput microplate arrangement, five of the six assays have a throughput of up to 15 samples per microplate (if only a single control is used per assay), while assay six acts as a sacrificial assay in which the per-microplate throughput is reduced by two relative to the other five assays. Alternatively, if assay six is deemed to be sufficiently stable to not require frequent control verification, its throughput can increased and the multi-analyte standards need not contain analyte 6.

It is also important to note that the control microwells employed in the preceding embodiments of the invention may also advantageously be used as a means of re-calibrating a dose-response curve for one or more assays of a microplate assay kit. This usage of the control microwells as recalibration microwells may find particular utility in analyzer systems that are susceptible to variations in external variables that affect assay performance, as described in concurrently filed U.S. patent application Ser. No. 11/334,749 filed Jan. 19, 2006. For example, in automated analyzer system that is susceptible to temperature changes, thermally-sensitive assays run on such a system can be re-calibrated via the assay signal or concentration measured for a control microwell, as described in detail within the aforementioned patent application. In another embodiment, thermally-sensitive assays may be re-calibrated by the assay signal form a reaction microwell in which reagents alone were dispensed, with no sample, control or calibrator added.

It is useful to recognize that in the preceding embodiments, the presence of distinct microwells containing standards cause inefficiencies due to the extra number of microwells needed for such standards and the additional liquid dispensing steps required for such standards. In this improved embodiment, one less microwell is required for each standard, and the dispensing of the standard occurs simultaneously with the dispensing of the reagent that resides in the microwell with the standard. This embodiment, which utilizes a microplate assay kit containing a “premix” of reagent and standard in some specific microwells, requires that all premixed reagents and standards are both mutually non-reactive (in the context of generating an assay signal) and stable for the required shelf life of the assay kit.

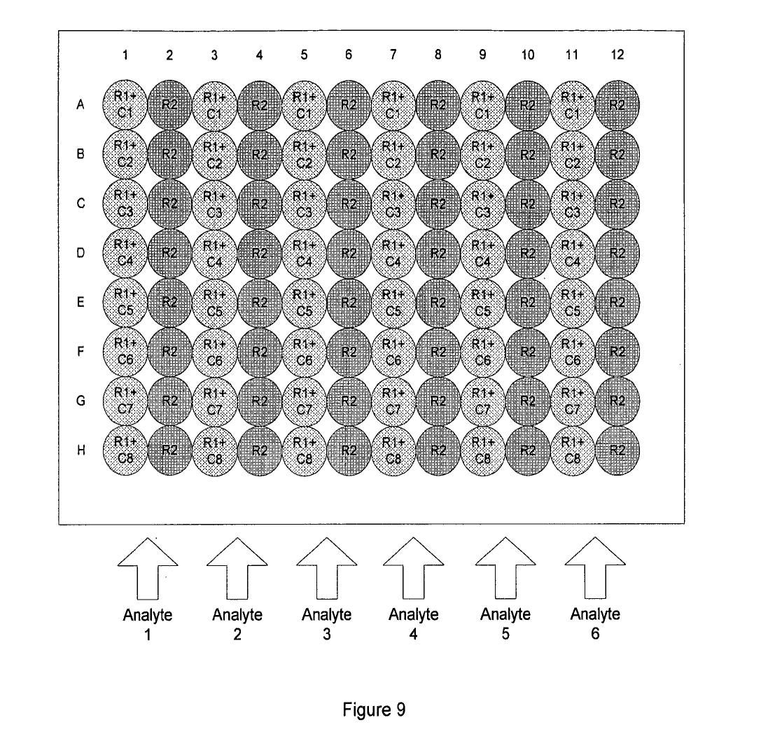

All of the previously described examples are readily adapted to the premixed configuration, as will be apparent to those skilled in the art. In particular, standards to be employed as calibrators or controls may be premixed with a reagent on a microplate. An exemplary calibration microplate according the aforementioned embodiment involving premixed reagents and standards is shown in FIG. 9. This calibration microplate performs the same role as both the reagent microplate of FIG. 3 and the calibration microplate of FIG. 4 when used to calibrate the six assays of the assay kit. The figure schematically shows all odd columns of the microplate containing a premix of R1 and a standard, enabling the calibration of each assay by simply combining the R1-standard premix and R2 in a reaction microplate microwell. A microplate assay kit according to the present example, in which six assays are provided, need only contain a single microplate according to FIG. 9 for assay calibration and one or more microplates according to FIG. 3 for the measurement of unknown samples.

Although the preceding embodiments of the invention have all been discussed in the context of microplates containing two-dimensional arrays of liquid reagents and standards, other embodiments may be contemplated that employ single linear arrays of microwells (i.e. the so-called “stripwell” microwell format). In a preferred form of this embodiment, the linear arrays contain eight microwells. For example, a multi-assay reagent microplate according to the present invention can comprise several single linear arrays of microwells that are assembled into a standard stripwell support rack. This embodiment allows for a mix-and-match approach to the configuration of microplates based on pre-sealed reagent stripwells, which is advantageous if a variety of permutations of reagents and standards are desirable for different applications.

Another useful extension of the invention involves the physical state of the reagents supplied in the microplate assay kit. In the previously described embodiments, the reaction microplate was deemed a standard consumable that is readily available to the user and therefore need not be considered as an essential ingredient of the microplate assay kit. However, in certain applications, such as performing automated ELISA assays, it may be preferable to provide one of the assay reagents (e.g. an antibody) in a solid phase within a sealed reaction microwell. Such sealed microwells with assay reagents or standards in a solid phase may be provided either as a single reaction microplate or as stripwells that are assembled into a stripwell support rack, as described above.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A transportable reagent storage microplate comprising:
a two-dimensional microwell array of microwells, wherein a spacing of microwells in said two-dimensional microwell array is compatible with a multichannel pipettor;
liquid reagents housed within a first linear microwell array and a second linear microwell array of said two-dimensional microwell array;
a machine readable label providing information associated with said liquid reagents; and
a sealing material enclosing said microwells to prevent leakage and evaporation of said liquid reagents;
wherein said liquid reagents are provided such that each microwell within said first linear microwell array includes a reagent of a first reagent type, and each microwell within said second linear microwell array includes a reagent of a second reagent type, such that multiple assays may be performed in parallel by dispensing, with the multichannel pipettor, reagents housed within microwells of said first linear microwell array and corresponding reagents housed within microwells of said second linear microwell array into a linear array of reaction microwells;
wherein each microwell of said first linear microwell array and each microwell of said second linear microwell array include a sufficient volume of reagent for performing two assays, such that when two assays are performed, an equal number of reaction microwells and reagent microwells are employed.

2. The microplate according to claim 1 wherein said first linear microwell array and said second linear microwell array are mutually adjacent within said two-dimensional microwell array.

3. The microplate according to claim 1 wherein a liquid reagent in one or more of said microwells is an enzymatic assay reagent.

4. The microplate according to claim 1 wherein said microwells of said first linear microwell array include a common first reagent of said first reagent type, and wherein said microwells of said second linear microwell array include a common second reagent of said second reagent type, such that said first linear microwell array and said second linear microwell array are configured for performing multiple common assays in parallel.

5. The microplate according to claim 4 further comprising an additional linear microwell array, wherein each microwell of said additional linear microwell array includes a calibrator for calibrating said common assay.

6. The microplate according to claim 5 wherein said microwells of said additional linear microwell array contain a range of analyte concentrations suitable for generating a dose-response curve when performing said multiple common assays in parallel.

7. The microplate according to claim 4 further comprising one or more additional pairs of linear microwell arrays, wherein each pair of linear microwell arrays includes reagents for a unique assay.

8. The microplate according to claim 7 wherein said two-dimensional microwell array is a 12 by 8 array including six pairs of linear microwell arrays.

9. The microplate according to claim 1 further comprising a microwell housing a calibrator, wherein said calibrator includes two or more pre-determined analyte concentrations.

10. The microplate according to claim 1 wherein a reagent in one or more microwells of said first linear microwell array or said second linear microwell array includes a pre-determined analyte concentration.

11. The microplate according to claim 1 wherein said two-dimensional microwell array is formed as a unitary structure.

12. The microplate according to claim 1 wherein said first linear microwell array and said second linear microwell array are columns of said microplate.

13. The microplate according to claim 1 wherein said liquid reagents are mix-and-read assay reagents.

14. A transportable reagent storage microplate comprising:
a two-dimensional microwell array of microwells, wherein a spacing of microwells in said two-dimensional microwell array is compatible with a multichannel pipettor;
liquid reagents housed within a first linear microwell array and a second linear microwell array of said two-dimensional microwell array;
a machine readable label providing information associated with said liquid reagents; and
a sealing material enclosing said microwells to prevent leakage and evaporation of said liquid reagents;
wherein said liquid reagents are provided such that each microwell within said first linear microwell array includes a reagent of a first reagent type, and each microwell within said second linear microwell array includes a reagent of a second reagent type, such that multiple assays may be performed in parallel by dispensing, with the multichannel pipettor, reagents housed within microwells of said first linear microwell array and corresponding reagents housed within microwells of said second linear microwell array into a linear array of reaction microwells.

15. A reagent storage microplate comprising:
a first linear microwell array, each microwell in said first linear microwell array containing a first liquid reagent;
a second linear microwell array, each microwell in said second linear microwell array containing a second liquid reagent, wherein a spacing of microwells in said first microwell linear array and said second linear microwell array is compatible with a multichannel pipettor;
a machine readable label providing information associated with said liquid reagents; and
a sealing material enclosing said microwells to prevent leakage and evaporation of said liquid reagents;
wherein a liquid reagent of a given microwell in said first linear microwell array and a liquid reagent in a corresponding microwell of said second linear microwell array may be employed to perform an assay for an analyte, such that multiple assays may be performed in parallel by dispensing, with the multichannel pipettor, liquid reagents housed within microwells of said first linear microwell array and corresponding reagents housed within microwells of said second linear microwell array into a linear array of reaction microwells.

16. The microplate according to claim 15 wherein each microwell of said first linear microwell array and each microwell of said second linear microwell array include a sufficient volume of reagent for performing two assays, such that when two assays are performed, an equal number of reaction microwells and reagent microwells are employed.

17. The microplate according to claim 15 wherein said first linear microwell array and said second linear microwell array are mutually adjacent.

18. The microplate according to claim 15 wherein a liquid reagent in one or more of said microwells is an enzymatic assay reagent.

19. The microplate according to claim 15 wherein said microwells of said first linear microwell array include a common first reagent and wherein said microwells of said second linear microwell array include a common second reagent, such that said first linear microwell array and said second linear microwell array are configured for performing multiple common assays in parallel.

20. The microplate according to claim 19 further comprising an additional linear microwell array, wherein each microwell of said additional linear microwell array includes a calibrator for calibrating said common assay.
